(19) United States
(12) Patent Application Publication
(10) Pub. No.: US 2011/0256346 A1
(43) Pub. Date: Oct. 20, 2011

(54) SYSTEMS AND METHODS FOR FORMING A PROTECTIVE PAD

(75) Inventors: Anton Edis Bowden, Lindon, UT (US); Robert David Campbell, Provo, UT (US); Russell Dibb, Durham, NC (US); Brandon Doyle, Sandy, UT (US); Daniel Lawson, Marysville, WA (US); Chad Pharo, Marietta, GA (US)

(73) Assignee: XOATHLETICS, LLC, Nyssa, OR (US)

(21) Appl. No.: 13/077,973

(22) Filed: Mar. 31, 2011

Related U.S. Application Data
(60) Provisional application No. 61/319,830, filed on Mar. 31, 2010.

(51) Int. Cl. A63B 71/08; B32B 5/18; B32B 3/28; B32B 27/08

(52) U.S. Cl. 428/138; 428/158; 428/159; 428/160

(57) ABSTRACT

A protective pad configuration is provided that includes a corrugated energy dispersing plate disposed between an upper and a lower foam member. The corrugated energy dispersing plate provides stiffness along a first direction and flexibility in a second direction to enable pad design that maximizes both athlete protection and mobility.

### RELATED APPLICATION

The present application claims the priority under 35 U.S.C. §119(e) of U.S. Provisional Patent Application No. 61/319,830, filed Mar. 31, 2010 titled “Protective Pad,” the contents of which are incorporated herein by reference in their entirety.

### FIELD

The present system and methods relate to protective pads. More specifically, the present exemplary system and methods relate to protective pads configured to disperse the energy associated with an impact.

### BACKGROUND

Protective shoulder pads and other sports related protective pads are worn by players in a number of contact sports, such as football, hockey, soccer, cricket, and lacrosse. Because of the physical nature of such sports, it is important for the protective gear to fit the players with the protective padding aligned with the intended areas on the players' bodies. Misaligned protective gear could jeopardize a player's safety. It is also important for the protective gear to fit comfortably. An uncomfortable fit could hinder a player's physical and mental performance.

Specifically, football shoulder pads are meant to protect athletes from injuries to their upper body. The focus of current shoulder pad design, in football for example, is impact dispersion. FIG. 1 illustrates a traditional shoulder pad assembly (20). As illustrated, the shoulder pad assembly (20) includes a flexible vest and a pair of rigid shoulder pads (24) attached to the vest (22). A pair of straps (30, 32) extends from a back portion of the vest (22) and is attached to a front portion of the vest (36). More particularly, a first strap (30) extending from a back right side of the vest is attached to a front right side (38) of the vest, and a second strap (32) extending from a back left side of the vest is attached to a front left side (40) of the vest (22).

The illustrated traditional shoulder pad assembly (20) may include a rigid upper shoulder pad (26) and a rigid lower shoulder pad (28) operatively connected to one another. For example, the upper shoulder pad (26) may be secured to the vest (22) atop the shoulder while the lower shoulder pad (28) is connected to the vest (22) by a strap. The lower shoulder pads may hang somewhat freely above the wearer's biceps, thus protecting the wearer while not hindering the wearer's freedom of movement. Additional examples of known traditional protective pads are shown in: U.S. Pat. No. 4,610,304; U.S. Pat. No. 4,985,931; U.S. Pat. No. 7,168,104; and U.S. Pat. No. 7,647,651.

Shoulder pads should not be overly heavy such that the player loses speed and energy nor overly bulky so as to limit the mobility of the player. Traditional athletic pad systems use a two piece system with a soft pad below a hard plastic shell. However, there are many different ways to effectively disperse impact, improve player safety, be lightweight, and allow for the player to remain mobile. By dispersing the energy of an impact more efficiently, a player will be able to play for longer periods of time due to reduced bodily injury and at higher levels due to increased mobility and confidence.

### SUMMARY

In one of many possible embodiments, the present exemplary protective pad includes a pad configuration for enhancing protection provided to athletes while reducing weight and improving mobility. Specifically, according to one exemplary embodiment, a protective pad configuration is provided that includes a corrugated energy dispersing plate disposed between at least one foam member, and in one embodiment, between an upper and a lower foam member. The corrugated energy dispersing plate provides stiffness along a first direction and flexibility in a second direction to enable pad design that maximizes both athlete protection and mobility.

According to another exemplary embodiment, the present exemplary protective pad includes a corrugated energy dispersing plate.

According to yet another exemplary embodiment, the present exemplary protective pad including a corrugated energy dispersing plate includes a plurality of holes configured to reduce overall weight while strengthening the structural integrity of the plate.

According to yet another exemplary embodiment, the present exemplary protective pad includes a living hinge that is configured to provide structural support to the protective pad in a first direction while enabling bending and mobility in a second direction.

According to one exemplary embodiment, a pad system includes a first foam member, a second foam member, and a structural member disposed between the first foam member and the second foam member, wherein the structural member assumes a substantially sinusoidal cross-sectional shape.

Yet another aspect of the disclosure may include any combination of the above-mentioned features and may further include the structural member being a polymer sheet.

Yet another aspect of the disclosure may include any combination of the above-mentioned features and may further include the first foam member and the second foam member each being one of a polyurethane foam or a SHOCKtec™ Air2Gel Foam.

Yet another aspect of the disclosure may include any combination of the above-mentioned features and may further include the structural member being one of a polypropylene or a polycarbonate material.

Yet another aspect of the disclosure may include any combination of the above-mentioned features and may further include the structural member being manufactured such that said sinusoidal cross-sectional shape has an average ratio of wavelength to height or amplitude (λ/H) of 2:1.

Yet another aspect of the disclosure may include any combination of the above-mentioned features and may further include the sinusoidal cross-sectional shape being maintained in a single direction to form ridges on a top surface of the structural member.

Yet another aspect of the disclosure may include any combination of the above-mentioned features and may further include the pad being configured to bend in a plane transverse to the ridges.

Yet another aspect of the disclosure may include any combination of the above-mentioned features and may further include the pad being positioned on an athletic shoulder pad assembly such that said ridges are oriented to mimic a natural movement of a player.

Yet another aspect of the disclosure may include any combination of the above-mentioned features and may further include a structural member having a sinusoidal cross-sectional shape exhibiting an average wavelength to amplitude ratio (λ/H) of 2:1.

Yet another aspect of the disclosure may include any combination of the above-mentioned features and may further include a structural member having a sinusoidal cross-sectional shape exhibiting an average wavelength to amplitude ratio (λ/H) ranging from approximately 0.5:1 to 4:1.

Yet another aspect of the disclosure may include any combination of the above-mentioned features and may further include a structural member having a cross-sectional shape exhibiting a varying wavelength to amplitude ratio throughout the structural member to predictably vary the bending characteristics of the protective pad.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a frontal view of a traditional shoulder pad assembly, according to one exemplary embodiment.

FIG. 2 is an exploded perspective view of a corrugated foam cell pad system, according to one exemplary embodiment.

FIG. 3A is a frontal cross-sectional view of a corrugated plate, according to one exemplary embodiment.

FIG. 3B is a frontal cross-sectional view of a corrugated plate as a force is imparted thereto, according to one exemplary embodiment.

FIG. 3C is a frontal cross-sectional view of a corrugated plate having an area of differing amplitudes, according to one exemplary embodiment.

FIG. 4 is a side cross-sectional view of a corrugated foam cell, according to one exemplary embodiment.

FIG. 5A is top view of a shoulder pad plate system, according to one exemplary embodiment.

FIG. 5B is a frontal view of a shoulder pad plate system, according to one exemplary embodiment.

FIG. 6 is a perspective view of a shoulder pad system, according to one exemplary embodiment.

FIG. 7 illustrates a top perspective view of a perforated plate system, according to one exemplary embodiment.

FIGS. 8A and 8B illustrate exemplary energy absorption and dispersion structures, according to various exemplary embodiments.

FIG. 8C is a side view of a living hinge, according to one exemplary embodiment.

FIG. 9 is a partial cross-sectional side view of a shoe including an energy absorption and dispersion structure, according to one exemplary embodiment.

Throughout the drawings, identical reference numbers designate similar, but not necessarily identical, elements.

### DETAILED DESCRIPTION

The present specification describes a system and a method for forming and using an exemplary protective pad. According to one exemplary embodiment, a pad configuration is provided for enhancing impact protection to athletes or any user wearing the pad while reducing weight and improving mobility. Specifically, according to one exemplary embodiment, a protective pad configuration is provided that includes a corrugated energy dispersing plate disposed between an upper and a lower foam member. According to one exemplary embodiment, the protective pad configuration is then encased in an encasement member. The corrugated energy dispersing plate disposed between the upper and lower foam members provides stiffness along a first direction and flexibility in a second direction to enable pad design that maximizes both athlete protection and mobility.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

As used in the present specification and in the appended claims, the term “sinusoidal” or “sinusoidal wave” shall be interpreted broadly to include any member or feature having a pattern that is similar to the curve of a sine function having crests and troughs. According to the present exemplary disclosure, a member having a “sinusoidal” or “sinusoidal wave” can exhibit varying amplitudes and frequency throughout the member. Additionally, the shape of the repeating waves may assume any number of shape profiles including, but in no way limited to, curves, triangles, squared corners, stepped waveforms, and the like.

Additionally, as used in the present specification and in the appended claims, the term “wavelength to amplitude ratio” (λ/H) shall be interpreted broadly as defining the ratio of the wavelength or period of the sinusoidal wave in relation to the amplitude value of the corresponding wavelength. Similarly, the term “average wavelength to amplitude ratio” shall be interpreted broadly as a ratio of the average wavelength or period of the sinusoidal wave in relation to the average amplitude value of the corresponding wavelength.

As mentioned, the present exemplary system and method provide pads to disperse impact energy so that there is a low transfer of the impact energy to the wearer. According to one exemplary embodiment, the present exemplary system may be incorporated into any number of impact absorption members including, but in no way limited to sports related pads, shoes, helmets, industrial protection equipment, combat gear, and the like. For consistency and ease of explanation only, the present protective pad system and configuration will be described in the context of a football pad system. However, it will be readily understood that the present exemplary protective pad configuration may be incorporated into any number of protective pad applications including, but in no way limited to, hockey pads, cricket pads, baseball pads, lacrosse pads, gloves, helmets, industrial protective clothing, shoes, riot gear, and the like.

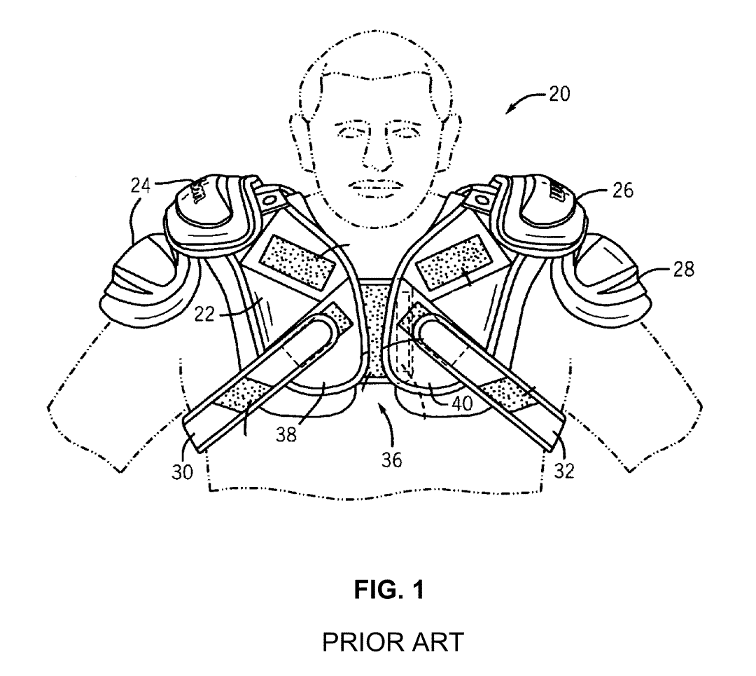

Traditional football based shoulder pad systems currently on the market, similar to those illustrated in FIG. 1, use a plastic plate (typically polypropylene) on the exterior of a foam cell to spread impact load over a larger area than the original impact. In contrast, the present exemplary system and method disperses impact by forming a plastic plate into an energy dispersion geometry configured to reduce or more fully distribute the impact energy the surrounding foam cell is to disperse.

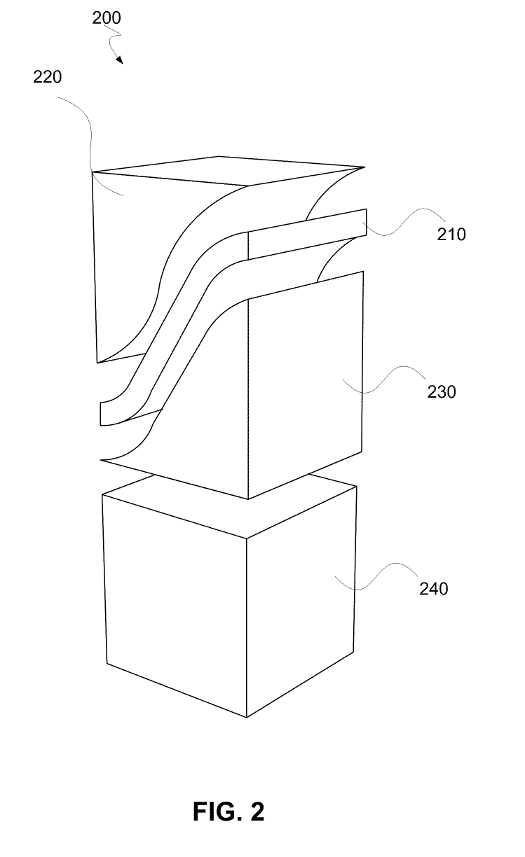

FIG. 2 is an exploded perspective view of a corrugated foam cell pad system configured to enhance protection and flexibility, while reducing weight, according to one exemplary embodiment. As illustrated, the exemplary foam cell pad system incorporates the idea of a corrugated plate into a dampening encasement. While the present exemplary system may be practiced by associating a corrugated plate with at least one bottom dampening member, such as a foam, the present exemplary system and method will be described, for ease of explanation only, as incorporating foam as the dampening member. However, it will be recognized that any number of dampening materials may be used including, but in no way limited to, a gel, an encased fluid, an aggregate material, and the like. According to one exemplary embodiment, the corrugated foam cell system (200) includes a foam upper (220) and a foam lower member (230) having a corrugated member (210) disposed there between. According to this exemplary embodiment, the foam upper (220) and lower (230) members work in conjunction with the corrugated member (210) to both absorb and disperse energy received during an impact, while providing enhanced mobility and range of motion to the user, when compared to traditional shoulder pad systems. Additionally, as illustrated in FIG. 2, additional foam (240) may be added to either side of the corrugated foam cell system (200) to modify the comfort of the system for the user. Further details of each component of the exemplary corrugated foam cell concept (200) will be provided below.

As noted above, the corrugated member (210) is disposed adjacent to at least one foam member, and, according to one exemplary embodiment, between a foam upper member (220) and a foam lower member (230). According to one exemplary embodiment, the foam upper member (220) and the foam lower member (230) may be formed of similar or disparate foam materials to vary both energy absorption and user feel. As used in the present specification, the term “foam” shall be interpreted as any substance that is formed by a trapping of gas bubbles in a liquid or a solid, and shall include open and closed cell configurations. According to one exemplary embodiment, a polyurethane foam may be used to form the foam upper member (220) and the foam lower member (230). Alternatively, any number of or combinations of foams may be used to form the foam upper member (220) and a foam lower member (230) including, but in no way limited to as quantum foam, polyurethane foam (foam rubber), XPS foam, Polystyrene, phenolic, Syntactic foam, or any other manufactured foam. According to one exemplary embodiment, the foam upper member (220) and the foam lower member (230) are formed out of commercially available SHOCKtec™ Air2Gel Foam for enhanced impact dispersion. The present exemplary systems and methods were initially implemented using polyurethane foam manufactured by Utah Foam Products (Nephi, Utah) having varying densities and stiffness.

According to the present exemplary system and method, the foam upper member (220) and the foam lower member (230) may be formed around the corrugated member (210) via any number of foam forming methods including, but in no way limited to foaming the foam members in place around the corrugated member (210), pressing the foam around the corrugated member, extruding the foam to mate with the corrugated member, adhering the foam around the corrugated member, mechanically fastening the foam to the corrugated member, shaving or otherwise shaping the foam to mate with the corrugated member, or otherwise forming the foam as is known in the art.

Additionally, as noted above, the exemplary corrugated foam cell concept (200) includes a corrugated member (210) formed of a structural material disposed between the foam upper member (220) and the foam lower member (230). According to this exemplary embodiment, the corrugated member (210) may be formed of any number of thermoplastics or other bendable structural materials. While the present exemplary system is described in the context of the plate being formed of polypropylene or polycarbonate, any number of structural materials may be used to form the corrugated plate including, but in no way limited to polypropylene, polycarbonate including Lexan® from SABIC Innovative Plastics, polyamides such as nylon, and the like. According to one embodiment, Lexan® from SABIC Innovative Plastics is used to form the corrugated member (210) due to its fracture resistance and relatively large modulus of elasticity.

According to one exemplary embodiment, the corrugated member (210) is formed to exhibit a sinusoidal cross-sectional shape. As noted above, while the present exemplary system is described as having a corrugated member (210) with a repeating curved pattern that is similar to the curve of a sine function having crests and troughs. According to the present exemplary system and method, the corrugated member (210) the corrugations of the corrugated member (210) may assume any number of shape profiles to form the alternating grooves and ridges including, but in no way limited to, curves, triangles, substantially squared corners, stepped wave forms, and the like.

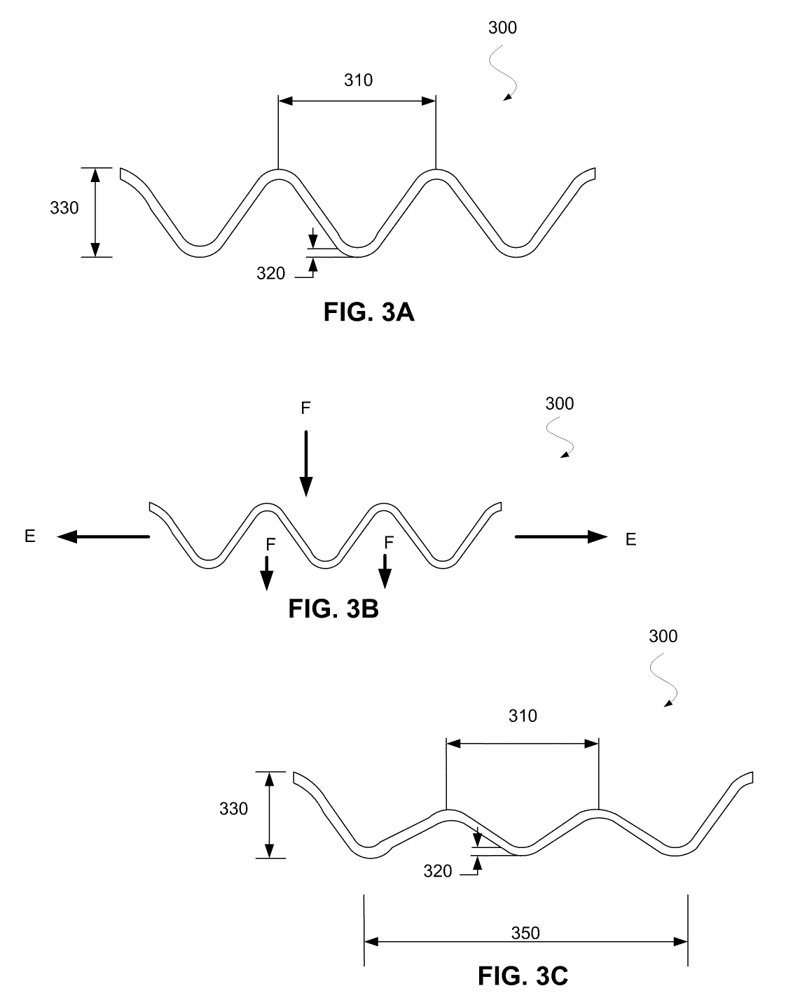

FIG. 3A is a frontal cross-sectional view of a corrugated member (210), according to one exemplary embodiment. According to the exemplary embodiment illustrated in FIG. 3A, the cross-sectional view of the corrugated member (210) assumes a consistent and repeating sinusoidal waveform. As illustrated, the cross-sectional member includes a number of measurable features that may be modified to vary the stiffness of the corrugated member (210) in the direction transverse to the ridges and to modify the impact strength, energy dispersion, and durability of the corrugated member or plate. As shown, the wave profile (300) may be modified according to peak to peak wavelength (310) or frequency, material thickness (320), and wave height (330) or amplitude. According to one exemplary embodiment, the wave profile used in the exemplary corrugated member (210) may have a peak to peak wavelength (310) of between 0.25 and 1.5 inches, a material thickness (320) of between approximately 0.015 and 0.1 inches, and a wave height (330) of between approximately 0.13 and 0.75 inches. According to one exemplary embodiment, the wave profile used in the exemplary corrugated member (210) may have a peak to peak wavelength (310) of approximately 0.5 inches, a material thickness (320) of approximately 0.031 inches, and a wave height (330) of approximately 0.25 inches. However, these parameters may be selectively varied to modify the resulting qualities of the corrugated member (210). Furthermore, according to one exemplary embodiment, the corrugated member properties assume an average wavelength to amplitude ratio (λ/H) of approximately 2:1. According to alternative embodiments, the exemplary wave profile (300) assumes an average wavelength to amplitude ratio (λ/H) ranging from approximately 1:1 to 3:1. According to other alternative embodiments, the exemplary wave profile (300) assumes an average wavelength to amplitude ratio (λ/H) ranging from approximately 0.5:1 to 4:1. Alternatively, the dimensions and parameters of the wave profile (300) may be further modified outside the ranges provided above to vary the pad properties according to varying needs and desired properties for various applications.

According to one exemplary embodiment, the use of a corrugated member (210) having the wave profile (300) illustrated in FIG. 3A provides numerous advantages to the resulting corrugated foam cell system (200). First, the use of the corrugated member (210) having a sinusoidal wave profile (300) increases the area over which an impact to the corrugated foam cell system (200) is dispersed for a defined length, relative to a system having a planar plate. Specifically, according to one exemplary embodiment illustrated in FIG. 3B, as the corrugated foam cell system (200) is impacted by a force (F), energy associated with that impact is translated through the foam to the corrugated member (210). As the energy from the force (F) reaches the varied surface of the corrugated member (210), the corrugated member (210) compresses vertically and expands (E) horizontally and energy is dispersed through the corrugation both perpendicular to the plane of the corrugation along multiple ridges, and parallel to the plane of the corrugation through the adjacent material.

According to one exemplary embodiment, the corrugated member (210) exhibits a nearly linear relationship between the applied force (F) and the deformation rates of the corrugated member for small deflections (approximately less than 35% of the original height and 20% of the original width). This linear relationship between the applied force (F) and the deformation rates allows for energy storage in the corrugated member (210) so that less of the impact force (F) is directly and immediately transferred to the body of the user as in the case of a flat plate.

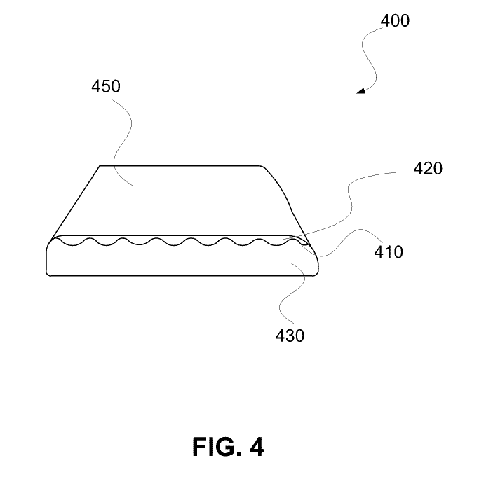

FIG. 4 illustrates an assembled corrugated foam cell pad (400), according to one exemplary embodiment. As shown, the assembled corrugated foam cell pad (400) includes a foam upper (420) and a foam lower member (430) having a corrugated member (410) disposed there between. Furthermore, as illustrated, a nylon or other appropriate encasing (450) surrounds the foam cell pad to provide wear protection to the exemplary system. As illustrated, the assembled corrugated foam cell pad (400) eliminates the traditional hard outer shell typically associated with shoulder pads. The elimination of the hard outer shell reduces injuries to body parts such as fingers and hands that may be impacted between two non-compressible surfaces. Additionally with a thick nylon encasing, the corrugated foam cell pad (400) will have sufficient durability to last for a number of years. Furthermore, according to one exemplary embodiment, the materials used in the construction of the protective pads allow the pad system to be washable as the exemplary system consists of water resistant materials such as polyurethane foam, nylon, and Lexan.

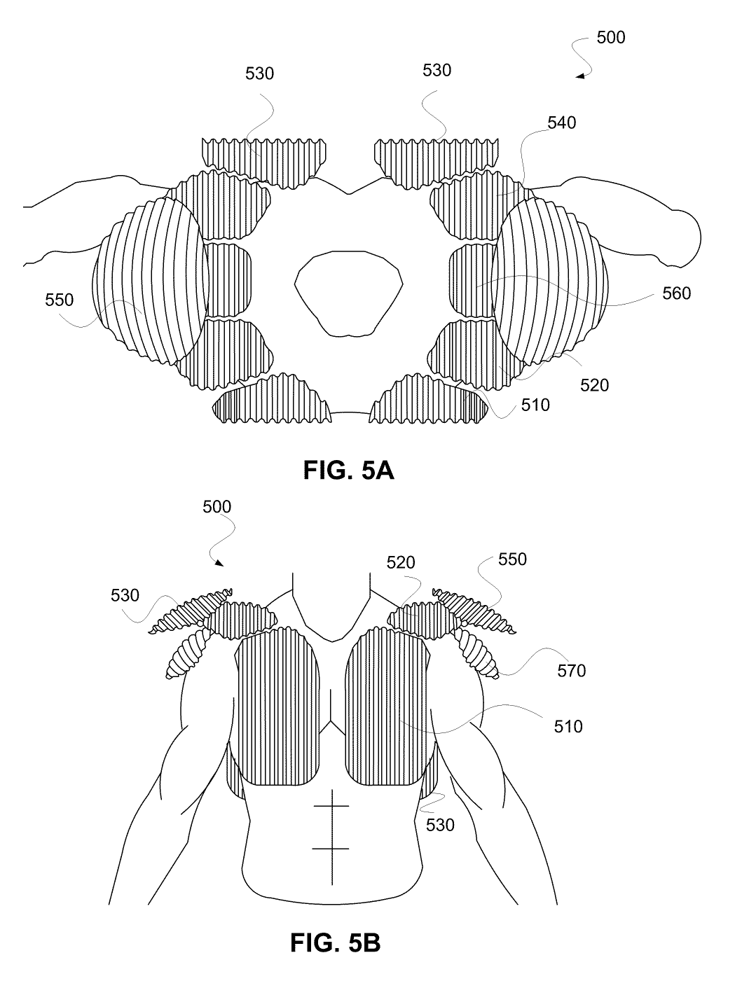

In addition to dispersing energy imparted from an impact, the present exemplary pad plate system simultaneously provides selective support and mobility to the athlete incorporating the system. Specifically, according to one exemplary embodiment, the wave profile (300) of the plate provides a high level of stiffness in the direction parallel with the ridges, while providing flexibility in the direction transverse to the ridges of the sinusoidal plate. That is, the present exemplary configuration allows the plate to be bent and rotated about an axis that is perpendicular with the ridges. According to one exemplary embodiment, as illustrated below in FIGS. 5A and 5B, the direction and orientation of the ridges, and consequently the unidirectional flexure of the plate, can be selectively designed to allow for maximum mobility for football players without compromising safety. Particularly, while the pads illustrated in the accompanying figures are illustrated, for ease of explanation, as including substantially linear ridges, the direction, orientation, and shape of the ridges may be modified to maximize player flexibility and limb movement, thereby enhancing player safety and performance. According to one exemplary embodiment, the ridges may be designed and oriented to closely align with the natural movement of an athlete's body.

While the exemplary corrugated member illustrated in FIGS. 3A, 5A, and 5B exhibit a consistent amplitude (330), wavelength (310), and thickness (320), the amplitude, wavelength, and thickness of the wave profile (300) of the corrugated member (210) can be varied to selectively introduce and design for areas of flexure. As illustrated in FIG. 3C, an area (350) of the wave profile (300) may have a reduced amplitude (330), wavelength (310), and/or thickness (320) to vary the bending properties of the resulting corrugated foam cell system (200).

Furthermore, as illustrated in FIGS. 5A and 5B, the exemplary system lends itself well to traditional shoulder pad configurations. Specifically, FIG. 5A is top view of a shoulder pad plate system, according to one exemplary embodiment. As shown, the exemplary plate system (500) includes a front chest plate (510) and a clavicle plate (520) to protect the frontal profile of a player. Additionally, a top deltoid plate (560) and back deltoid plate (540) are positioned to protect the upper shoulder portion of a player. FIG. 5B further illustrates a bottom deltoid plate (570) to protect the outer shoulder portion of a player and to maximize player safety and mobility. Additionally, as illustrated, an epaulet plate (550) is formed above the deltoid plates (540, 560) to further protect the often maligned shoulder area. Moreover, as illustrated in both FIGS. 5A and 5B, the exemplary plate system includes a back plate (530) to protect a player from rear oriented impact. While FIGS. 5A and 5B illustrate an exemplary plate configuration, any number of positional and/or shape modifications may be made to enhance mobility and/or to protect injury susceptible areas of the player. The identified pad locations were selected based on both traditional shoulder pad location and orientation, as well as shoulder, arm, and head mobility. However, selective modifications may be made to pad location, shape, size, and orientation, depending on the needs of the athlete.

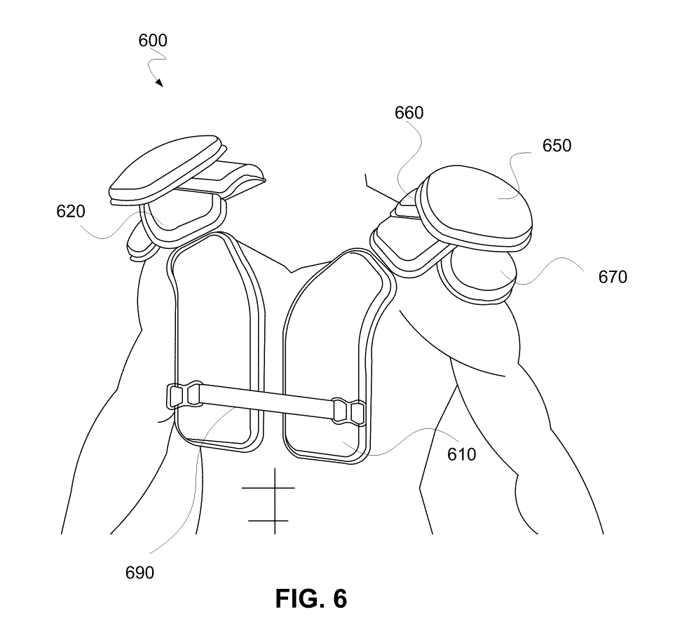

FIG. 6 is a perspective view of a shoulder pad system (600), according to one exemplary embodiment. As illustrated in FIG. 6, the exemplary plate system (500) illustrated in FIGS. 5A and 5B are incorporated into a fully functional and covered corrugated foam cell system. As illustrated, the shoulder pad system (600) includes the front chest pad (610) and a clavicle pad (620) to protect the frontal profile of a player. Additionally, a top deltoid pad (660) and back deltoid pad (not shown) are positioned to protect the upper shoulder portion of a player. A bottom deltoid plate (670) is also illustrated to protect the outer shoulder portion of a player and to maximize player safety and mobility. Furthermore, an epaulet plate (650) is formed above the deltoid plates (660). Moreover, FIG. 6 illustrates the incorporation of a fastening system (690) to couple the system to a player. While a buckled strap system is illustrated in FIG. 6, it will be understood that any number of pad fastening systems may be used with the present exemplary system and method including, but in no way limited to a buckle system, a lace system, a snap system, a Velcro system, and the like.

### Alternative Embodiments

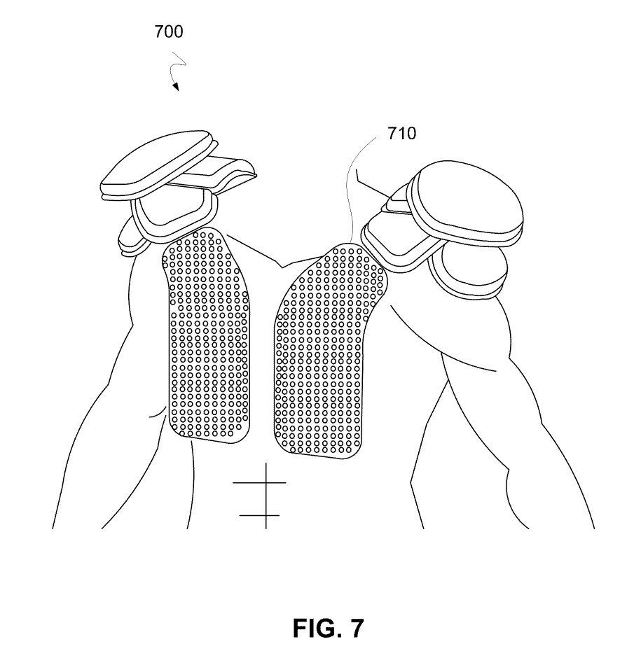

In addition to the above-mentioned pad configurations, modifications may be made to the underlying plate system to vary the weight and characteristics of the resulting pad system. According to one exemplary embodiment, the FIG. 7 illustrates a top perspective view of a perforated plate system (700) configured to reduce the overall weight of the system described above. As illustrated, a number of orifices may be formed in selective structural plates (710). Formation of the holes in the structural plates (710) could increase the toughness of the shell as there are more edges in the shell with all the holes. According to this exemplary embodiment, the holes are formed in the plastic and then the resulting plastic plate is annealed by bringing it to a moderate temperature for a period of time. According to one exemplary embodiment, the plastic plate is annealed at approximately 100-185 degrees Fahrenheit, for a time period of between approximately 4-5 hours. Alternatively, according to one exemplary embodiment, the holes may be formed by laser cutting to simultaneously remove material and anneal the remaining material, thereby reducing stress points.

According to one alternative embodiment, the foam may be replaced with another dampening material. According to this exemplary embodiment, one or more of the foam upper (220) and a foam lower member (230) may be replaced by or further include additional dampening materials including, but in no way limited to gels, fluids, particulates, and the like.

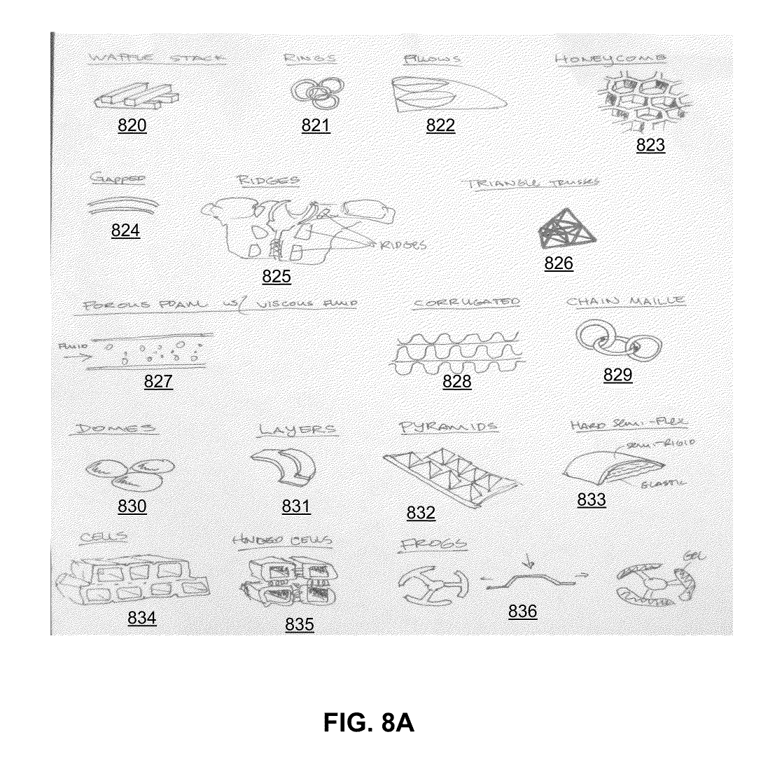

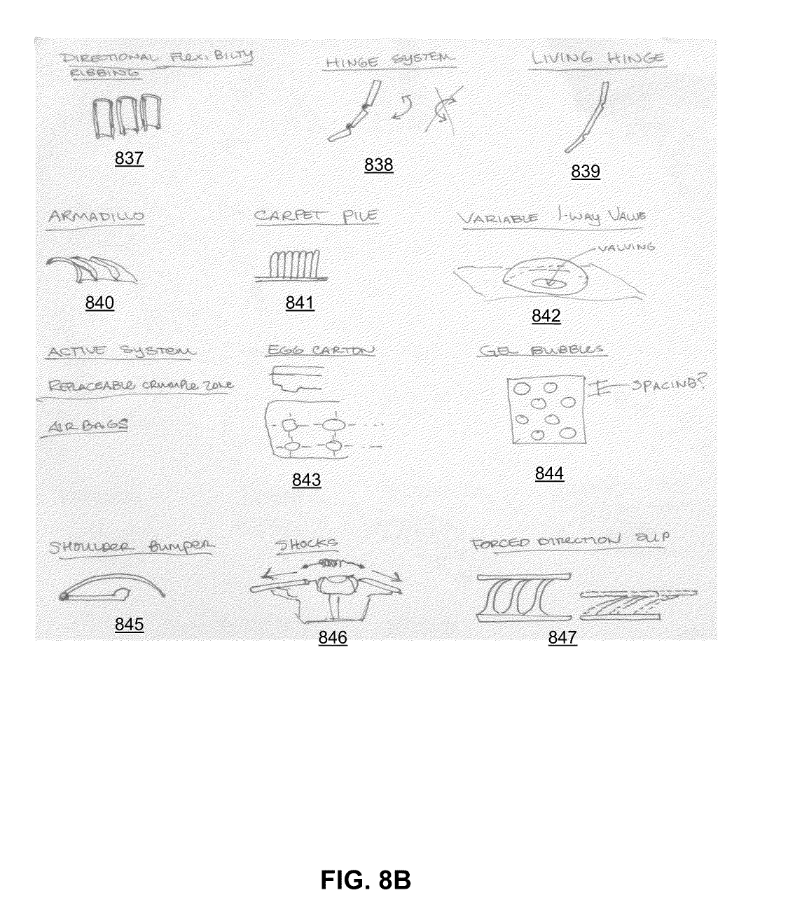

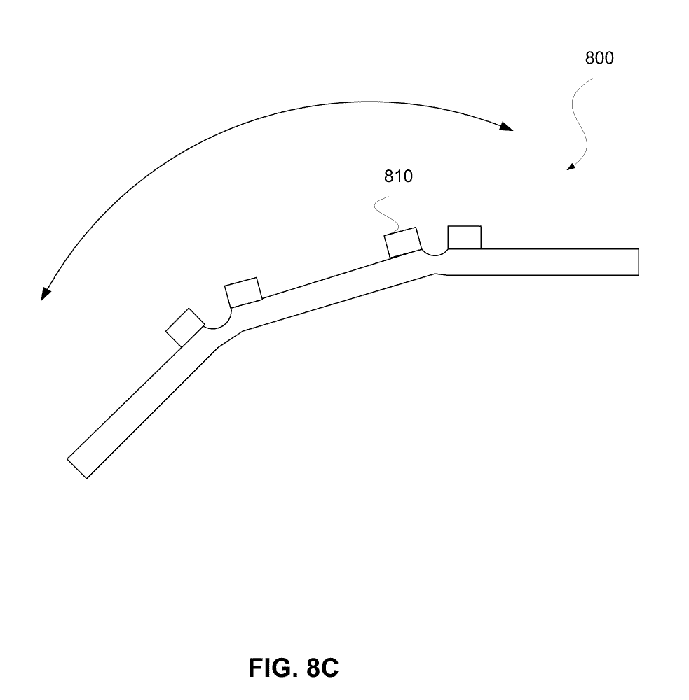

Furthermore, FIGS. 8A and 8B illustrate exemplary energy absorption and dispersion structures, according to various exemplary embodiments. As illustrated, a number of alternative structures may be incorporated in to the present exemplary system and method to selectively disperse impact energy while providing mobility to athletes. As illustrated, energy absorbing structures and configurations may include, but are in no way limited to, a waffle stack, overlapping rings, pillows, honeycomb structure, gapped planes, impact absorbing ridges, triangle trusses, porous foam with viscous fluid, layered corrugated surfaces, chain maille, domes, dimples, sliding layers, pyramids, semi-flexible structures, open cells, hinged cells, three-dimensional legged support structures, directional ribbing, hinged systems, living hinge, overlapping armadillo-like plates, pile type protrusions, variable one-way valve, egg carton configuration, gel bubbles, shoulder bumper, shocks, forced directional slip members, and the like.

FIG. 8C illustrates a living hinge structure that may be selectively incorporated into the present exemplary pad system, according to one exemplary embodiment. As illustrated, a living hinge (800) is a thin, flexible segment of plastic connecting more rigid components that allows for compliant rotational motion along the line of axis of the hinge. This concept was discovered and first used in 1957 and is commonly used in many commercial products. A variation of the living hinge provides mechanical stops (810) to hinge motion in one or both directions. The application of a mechanically limited living hinge to player protection technology allows for maximum player mobility, while retaining the protective qualities of the construct. For example, according to one exemplary embodiment, the mechanically limited living hinge can be employed to provide segmented protection for rigid portions of the shoulder area of a football pad. Another use would employ the mechanically limited living hinge as an attachment between other protection systems such as the corrugated sections or foam-encased corrugated sections discussed elsewhere.

According to yet another alternative embodiment, the present exemplary system and method may be incorporated into any number of articles worn or used by humans. According to one embodiment, the present system and methods may be incorporated into a shoe. The shoe base plays a critical role in comfort, protection, and athletic performance. The mechanical characteristics of a shoe base are represented by its elastic stiffness (providing energy return), energy absorption, and energy dispersion. These mechanical characteristics are obtained through a combination of material selection and geometric design. Previous shoe base implementations have utilized a wide variety of materials (synthetic polymers, foams, leather, natural rubbers, etc.) either by themselves, layered to form a composite, or integrated to provide a synergistic effect. These materials have been combined with a wide variety of geometric inclusions and/or voids to obtain a customized stiffness, energy absorption, and/or energy dispersion to provide a potential benefit for the wearer.

According to the present exemplary alternative embodiment, the present exemplary system and method is incorporated into a shoe to provide a particular combination of material properties and geometric features that result in increased energy dispersion and customized elastic stiffness when compared to traditional shoe systems. With a suitable choice of viscoelastic material, the system can also provide customized energy absorption.

As noted above, a corrugated energy dispersing plate is interposed between layers of foam, polymer, leather, or other material such that as energy is imparted to the plate, it is dispersed both through the plate and parallel to the plane of the plate. This plate may or may not contain a plurality of holes configured to reduce weight while strengthening the structural integrity of the plate. The geometry of the corrugation provides for distinct elastic stiffness in directions parallel to the centerlines of the corrugation patterns as compared to directions perpendicular to the centerlines of the corrugation patterns. This feature of the corrugation geometry can provide enhanced flexibility in one preferred direction while providing increased stiffness in other directions and is desirable in a shoe base.

As illustrated noted above, choice of corrugation wavelength (spacing) and amplitude (height), combined with choices of the materials allow customization of elastic stiffness, energy dispersion, and energy absorption of the system.

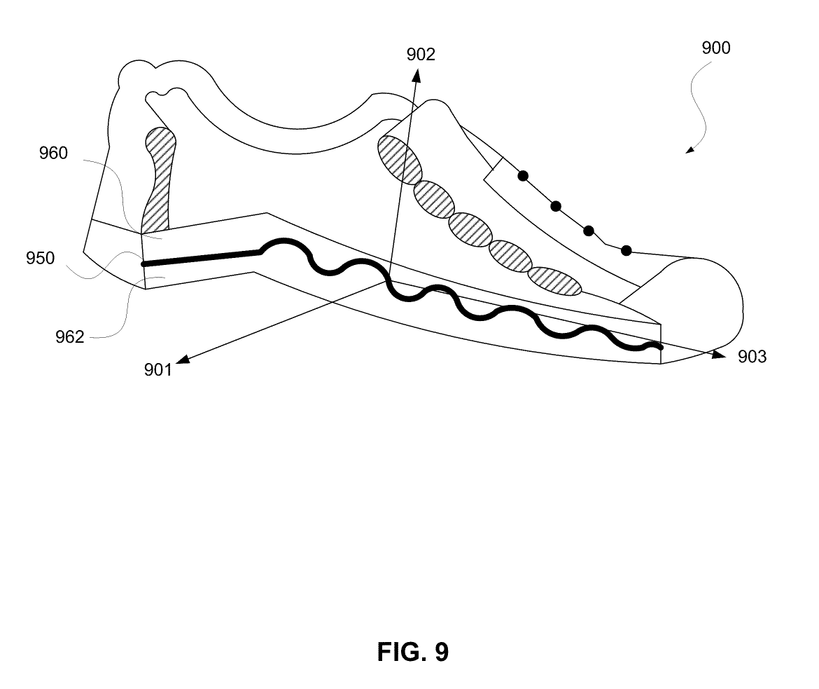

FIG. 9 illustrates a shoe (900) incorporating a corrugated energy dispersing plate (950) that is interposed between dampening layers (960, 962) of foam, polymer, leather, or other material such that as energy is imparted to the plate, it is dispersed both through the plate and parallel to the plane of the plate. Further, the arrows of FIG. 9 show how an exemplary embodiment of the system aligns the centerline of the corrugation with a bending axis (901) to provide flexibility in that axis, while providing increased stiffness in the perpendicular directions (902, 903).

While the present protective pad system has been described in the context of protective pads for athletic events, the present exemplary system and method may also be applied to any structure or article of clothing configured to provide enhanced safety to the user while maintaining flexibility and reducing weight. By way of example, the present exemplary protective pad system may be incorporated in to any number of sports pads, helmets, toe guards, shoe tops, hard hats, and other construction safety equipment.

According to one exemplary embodiment, the present exemplary system and method may be incorporated into a football and/or baseball helmet to prevent damage to a user's brain, such as by a concussion. As noted above, the use of the present exemplary system including both the foam upper member (220) and the foam lower member (230) will help prevent concussions in a number of ways. First, if incorporated into a helmet and/or pads, the impact between the equipment incorporating the present exemplary system will have a substantially soft outer surface that will not impart as much instantaneous force as a rigid member striking a rigid member—such as traditional helmet striking another helmet or a traditional shoulder pad. Furthermore, the player using the helmet incorporating the present exemplary system will have less of an instantaneous force imparted from the collision as the energy is dispersed throughout the helmet. According one exemplary embodiment, the corrugated member (210) disposed in a helmet embodiment may assume more of an egg carton shape, free of directional ridges, in order to disperse any number of impacts thereto without imparting a directional rigidity.

In conclusion, the present exemplary system and method provides a pad configuration for enhancing protection provided to athletes while reducing weight and improving mobility. Specifically, according to one exemplary embodiment, a protective pad configuration is provided that includes a corrugated energy dispersing plate associated with at least one dampening member. Specifically, according to one exemplary embodiment, the energy dispersing plate is disposed between an upper and a lower foam member. The corrugated energy dispersing plate provides stiffness along a first direction and flexibility in a second direction to enable pad design that maximizes both athlete protection and mobility.

The preceding description has been presented only to illustrate and describe embodiments of the present exemplary pad structure and system. It is not intended to be exhaustive or to limit the invention to any precise form disclosed. Many modifications and variations are possible in light of the above teaching.

What is claimed is:

1. A pad system, comprising;
a first foam member; and
a structural member coupled to said first foam member, wherein said structural member has a sinusoidal cross-sectional shape.

2. The pad system of claim 1, further comprising a second foam member, wherein said structural member is disposed between said first foam member and said second foam member.

3. The pad system of claim 1, wherein said structural member comprises a polymer sheet having a sinusoidal cross-sectional shape.

4. The pad system of claim 3, wherein said structural member comprises one of a polypropylene, a polycarbonate, or a polyamide.

5. The pad system of claim 4, wherein said structural member comprises Lexan®.

6. The pad system of claim 1, wherein said structural member has a sinusoidal cross-sectional shape with an average wavelength to amplitude ratio (λ/H) of 2:1.

7. The pad system of claim 1, wherein said structural member has a sinusoidal cross-sectional shape with an average wavelength to amplitude ratio (λ/H) between approximately 0.5:1 and 4:1.

8. The pad system of claim 1, wherein said cross-sectional shape has a wave profile with a peak to peak wavelength between approximately 0.25 and 1.5 inches, a material thickness between approximately 0.015 and 0.1 inches, and a wave height of between approximately 0.13 and 0.75 inches.

9. The pad system of claim 1, wherein said first foam member comprises one of a polyurethane foam or a SHOCKtec™ Air2Gel Foam.

10. The pad system of claim 1, wherein said sinusoidal cross-sectional shape is maintained in a single direction to form ridges on a top surface of said structural member.

11. The pad system of claim 10, wherein said pad is configured to bend in a plane transverse to said ridges.

12. The pad system of claim 11, wherein said pad is positioned on an athletic shoulder pad assembly such that said ridges are oriented to mimic a natural movement of a player.

13. The pad system of claim 1, wherein said structural member is configured to store energy via a shape deformation in response to an impact.

13. The pad system of claim 1, wherein said structural member defines a plurality of orifices formed in said structural member.

14. A pad system, comprising;
a first foam member;
a second foam member; and
a structural member disposed between said first foam member and said second foam member, wherein said structural member has a sinusoidal cross-sectional shape;
wherein said structural member comprises a polymer sheet having a sinusoidal cross-sectional shape.

15. The pad system of claim 14, wherein said structural member comprises one of a polypropylene, a polycarbonate, or a polyamide.

16. The pad system of claim 14, wherein said structural member has a sinusoidal cross-sectional shape with an average wavelength to amplitude ratio (λ/H) between approximately 0.5:1 and 4:1.

17. The pad system of claim 14, wherein said cross-sectional shape has a wave profile with a peak to peak wavelength between approximately 0.25 and 1.5 inches, a material thickness between approximately 0.015 and 0.1 inches, and a wave height of between approximately 0.13 and 0.75 inches.

18. The pad system of claim 14, wherein said first foam member and said second foam member each comprise one of a polyurethane foam or a SHOCKtec™ Air2Gel Foam.

19. The pad system of claim 14, wherein said sinusoidal cross-sectional shape is maintained in a single direction to form ridges on a top surface of said structural member;
wherein said pad is configured to bend in a plane transverse to said ridges; and
wherein said structural member is configured to store energy via shape deformation in response to an impact.

20. A pad system, comprising;
a first polyurethane foam member;
a second polyurethane foam member; and
a structural member disposed between said first foam member and said second foam member, wherein said structural member has a sinusoidal cross-sectional shape;
wherein said structural member comprises a polycarbonate having a sinusoidal cross-sectional shape;
wherein said sinusoidal cross-sectional shape has an average wavelength to amplitude ratio (λ/H) of approximately 2:1 and a wave profile with a peak to peak wavelength of approximately 0.5 inches, a material thickness of approximately 0.031 inches, and a wave height of approximately 0.25 inches; and
wherein said sinusoidal cross-sectional shape is maintained in a single direction to form ridges on a top surface of said structural member, said pad is configured to bend in a plane transverse to said ridges, and said structural member is configured to store energy via shape deformation in response to an impact.
